(19) United States
(12) Patent Application Publication
(10) Pub. No.: US 2026/0329309 A1
(43) Pub. Date: Oct. 22, 2026

(54) ELECTROMAGNETIC COUPLER SYSTEM FOR INDUSTRIAL MACHINES

(71) Applicant: Caterpillar Paving Products Inc., Brooklyn Park, MN (US)

(72) Inventors: Todd Jennings, Ramsey, MN (US); Conwell K. Rife, Hanover, PA (US); Eric S. Engelmann, Delano, MN (US)

(21) Appl. No.: 19/184,882

(22) Filed: Apr. 21, 2025

(51) Int. Cl. G05D 1/695; B60K 35/28; B60Q 9/00; G05D 107/70; H01F 7/18

(52) U.S. Cl. CPC G05D 1/695; B60K 35/28; B60Q 9/00; H01F 7/18; B60K 2360/178; G05D 2107/70

(57) ABSTRACT

Disclosed herein is an intelligent electromagnetic coupler system for industrial machines, such as trucks. The system can include an electromagnetic device on a first machine and a coupling element on a second machine. The coupling element can include an electromagnetic attraction surface to connect the coupling element to at least a portion of the electromagnetic device.

### BACKGROUND

The term “industrial equipment” refers to heavy-duty machinery that can be used in manufacturing, construction, or other industrial settings. Industrial equipment can include a wide range of machines, such as trucks, pavers, cold planers, conveyors, generators, excavators, forklifts, boilers, and other equipment.

### BRIEF DESCRIPTION OF THE DRAWINGS

Detailed descriptions of implementations of the present invention will be described and explained through the use of the accompanying drawings.

FIG. 1A is a component diagram showing an example electromagnetic coupler system for securing a work machine to a host machine, according to some arrangements.

FIG. 1B is a component diagram showing example control mechanisms of the electromagnetic coupler system, according to some arrangements.

FIGS. 2A, 2B, 3, and 4 are component diagrams showing example use cases for the electromagnetic coupler system, according to some arrangements.

FIG. 5 is a flowchart showing an example control method for the electromagnetic coupler system, according to some arrangements.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

In an example that illustrates a use case for industrial machinery, a dump truck can be connected to a paver in road construction and asphalt-laying projects. The dump truck can carry and transport asphalt or aggregate materials from a quarry or production site to the construction location, delivering them to the paver. The paver can receive the materials and spread them evenly onto the road surface. Using connected pieces of industrial equipment in combination enables efficient and continuous asphalt laying, ensuring a smooth and even road surface. When connected, dump trucks and pavers are synchronized to prevent accidents and ensure smooth operation.

As yet another example, in road resurfacing and reconstruction projects, cold planers and dump trucks are connected to streamline asphalt removal and hauling. The cold planer mills and removes damaged asphalt, loading it into the dump truck. The dump truck transports the milled asphalt to recycling facilities or disposal sites. Synchronized control ensures efficient operation, with skilled operators manually regulating asphalt removal rates, loading processes and truck positioning, optimizing asphalt removal, reducing downtime, and enhancing road resurfacing efficiency.

Conventionally, skilled operators manually control the machines to prevent collisions and maintain machine relative positions. Manual operation of connected construction equipment poses several technical problems, including communication delays, inconsistent control, limited visibility, equipment synchronization challenges, safety risks, inefficiency, scalability issues, data tracking limitations, maintenance difficulties, and training requirements. These challenges arise from human factors like operator fatigue, distractions, and mistakes, reducing productivity and increasing downtime. Automating these processes can mitigate these issues, enhancing safety, efficiency, and overall project management. Techniques that involve attaching two machines (e.g., via conventional mechanical or electromagnetic means without advanced sensing and control circuitry, such as those described in connection with U.S. Pat. No. 11,794,345) do not mitigate likely synchronization errors, where inaccurate timing can cause mismatches in equipment operation. Furthermore, merely attaching two machines via conventional means does not prevent positional uncertainty, where a lack of automatic spatial awareness can lead to collisions.

As disclosed, a host machine (e.g., dump truck, water truck) can be coupled to a work machine (e.g., paver, rotary mixer, cold planer) through an electromagnetic coupler system, which can ensure efficient and secure material transfer during various construction operations. The electromagnetic coupler system can include various mechanisms, such as a proximity detection mechanism, a coupling mechanism, a spacing control mechanism, an alignment control mechanism, a stabilization control mechanism, and/or an emergency release mechanism. Accordingly, the electromagnetic coupler system can enable proximity detection, alignment, quick connection/disconnection, and collision avoidance while minimizing the downtime ordinarily needed to couple host and work machines via conventional means. The electromagnetic coupler system can also include a set of control mechanisms and interfaces to provide real-time data to operator(s) of the work machine, host machine, or both, which can further reduce the possibility of suboptimal operation or collision.

In an example, the electromagnetic coupler system can include an electromagnet housing on the host machine's rear frame and an armature plate on the work machine's front frame. When engaged, the electromagnet can securely attach to the armature plate, forming a stable connection. The coupling can facilitate continuous material flow from the host machine to the work machine, optimizing material distribution and promoting uniform results. The electromagnetic coupler system can therefore enhance operational efficiency and reduce labor requirements.

As used herein, the term “set” refers to a physical or logical collection of objects, which can contain no objects (e.g., a null set, an empty set), one object, or two or more objects. The terms “engine,” “application,” “program,” “circuit,” and “executable” refer to one or more sets of computer-executable instructions, in compiled or executable form, that are stored on non-transitory, computer-readable media and can be executed by one or more processors to perform software-and/or hardware-based computer operations. The computer-executable instructions can be special-purpose computer-executable instructions to perform a specific set of operations, as defined by parametrized functions, specific configuration settings, special-purpose code, and/or the like. Engines, applications, programs, and executables can generate and/or receive various signals, which can be transmitted in the form of electronic messages.

### Example Electromagnetic Coupler System

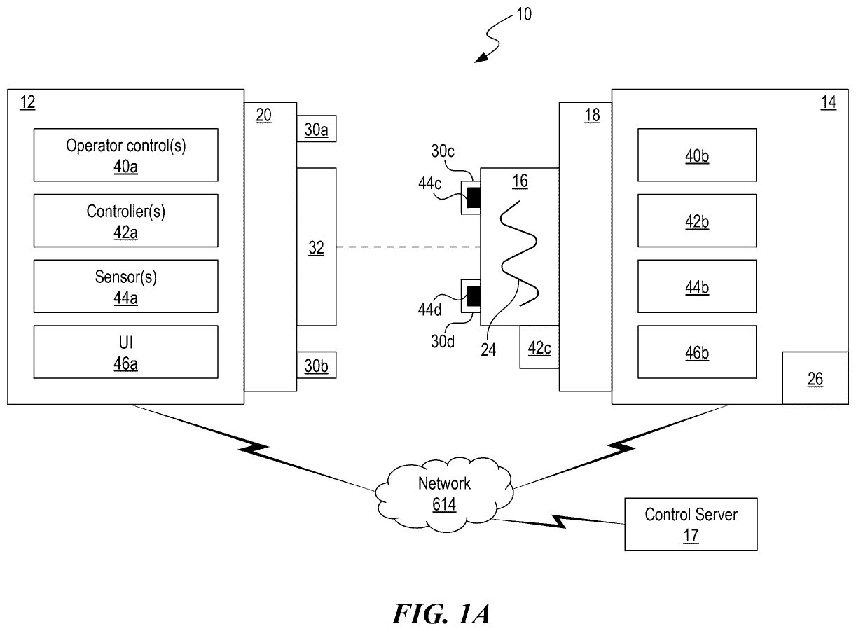

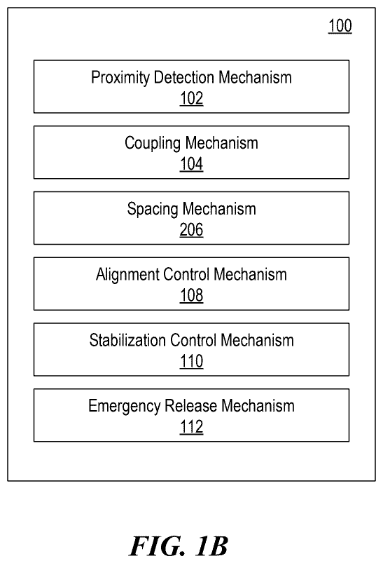

FIG. 1A is a component diagram showing an example electromagnetic coupler system 10 for securing a work machine 12 to a host machine 14, according to some arrangements. In industrial settings, work machines such as pavers, rotary mixers, cold planers, cranes, excavators, concrete pumps, asphalt laydown machines, grinding machines, material handlers, and/or drilling rigs can be paired with host machines such as dump trucks, water trucks, Windrow elevators, material transfer vehicles (MTVs), cement mixers, fuel trucks, loader trucks, low-bed trailers, tanker trucks, flatbed trucks, semi-trailer trucks, and service trucks. These connected equipment combinations can be utilized in various industries, including construction, mining, quarrying, manufacturing, infrastructure development, demolition, recycling, landfill management, and/or agricultural material handling. Examples of paired equipment include pavers and dump trucks for asphalt laying, rotary mixers and water or emulsion trucks for reclamation and stabilization, and cold planers and dump trucks for asphalt milling.

As shown, the electromagnetic coupler system 10 can include, operably connect, or secure a work machine 12 to a host machine 14. To enable such a connection, the electromagnetic coupler system 10 can include an electromagnet housing 16, which can have disposed therein electromagnetic coil(s) 24. The electromagnet housing 16 can be mounted on the mounting element 18 of the host machine 14. In an example implementation, the mounting element 18 is a rear frame of the host machine. In various implementations, mounting elements 18 can include various other suitable mounting elements, which can be selected for accessibility, structural integrity, electromagnetic interference (EMI) minimization, and/or protection from environmental elements.

In some implementations, the mounting element 18 and its associated components can be positioned on the work machine 12 rather than the host machine 14, and, correspondingly, coupling element 20, guides 30a and/or 30b, and magnetic attraction surface 32 can be positioned on the host machine 14 rather than work machine 12.

In some implementations, the electromagnetic housing 16 can include suitable shielding and/or filtering components to reduce EMI interference and noise susceptibility of the electromagnetic coupler system 10. For example, the electromagnetic housing 16 can include electromagnetic shielding components (e.g., shielded cables or enclosures), noise filters (e.g., EMI filters, RFI filters), and/or band-pass filters to allow specific frequency ranges.

As shown, the electromagnetic coupler system 10 can operably connect to or include a suitable coupling element 20. The coupling element 20 can be included in the work machine 12 and/or can be fixedly or removably attached to the work machine 12. For example, the coupling element 20 can include an armature plate attached to or disposed on the front frame of the work machine 12. In various arrangements, the coupling element 20 can include brackets, arms, metal plates, couplers, attachments, adapters, connectors, clamps, quick connect/disconnect systems, or other suitable components operable to attach to host machines.

Generally, the coupling element 20 of the electromagnetic coupler system 10 will include a magnetic attraction surface 32. After the electromagnetic coil(s) 24 in the housing 16 are activated using a power supply 26 of the electromagnetic coupler system 10 (e.g., after electric current starts flowing through the electromagnetic coil(s) 24), the magnetic attraction surface 32 of the coupling element 20 can connect to at least a portion of the surface of the housing 16, thereby securely connecting the work machine 12 to the host machine 20.

In some implementations, any or all of the housing 16, mounting element 18, coupling element 20, and/or magnetic attraction surface 32 can have included or disposed thereon a set of alignment guides (30a, 30b, 30c, 30d) operable to ensure alignment between the housing 16, mounting element 18, coupling element 20, and/or magnetic attraction surface 32 during a connection.

The alignment guides (30a, 30b, 30c, 30d) can be or include mechanical alignment guides (pins and sockets, guiding rails, cam locks), optical alignment guides (laser and/or camera-assisted), sensor-based alignment guides (e.g., using any of the sensors (44a, 44b, 44c, 44d), which can be, for example, proximity and/or magnetic sensors), or a combination thereof. For example, mounting element 18 can include pins that engage sockets on the coupling element 20, can have rails that mate with corresponding grooves on the coupling element 20, can include cam locks for engaging an armature plate of the coupling element 20, can include laser beam emitters to guide alignment of the work machine 12, can include cameras that monitor the relative positions of the work machine 12 and the host machine 14, and so forth. The alignment guides (30a, 30b, 30c, 30d) can be or include adjustable guides that include adjustable pins and sliding rails. Hybrid alignment guides (30a, 30b, 30c, 30d), such as sensor-mechanical and/or optical-mechanical hybrids, can combine various components, such as sensors, cameras, guiding rails, and so forth, to facilitate alignment while the machines are connected.

As shown, the mounting element 18 (and, accordingly, the electromagnetic housing 16) of the electromagnetic coupler system 10 is positioned on the host machine 14, and the coupling element 20 of the electromagnetic coupler system 10 is positioned on the work machine 12. However, various other configurations are contemplated and can be influenced by factors such as weight, balance, structural integrity, electromagnetic interference, maintenance accessibility, cost, and safety. For example, the mounting element 18 can be installed on the work machine for smaller equipment (e.g., certain pavers, certain concrete pumps). For larger work machines 12 (e.g., certain cranes, certain excavators) or complex host systems, the mounting element 18 can be installed on the host machine 14 for improved weight distribution and control.

Other factors that can influence the choice of the mounting machine between work machine 12 and host machine 14 include applications (e.g., construction, mining, manufacturing). For example, in certain construction use cases, it can be advantageous to install the electromagnetic housing 16 on the work machine 12. Work machine installation can allow easier reconfiguration of machine couplings such that a particular work machine can be connected to various host machines as needed. Furthermore, mobility requirements of work machines can make it advantageous to include self-contained electromagnets. In mining, work machine installation can protect electromagnets from extreme conditions in harsh environments, and comparatively heavier work machines (drilling rigs, loaders) can more easily support electromagnet weight. In manufacturing applications, it can be advantageous to install electromagnets on host devices to enable centralized control systems, permanent host machine installations, and scalability (e.g., having a host machine accommodate multiple work machines).

To that end, one of skill will appreciate that various modes of installation, operation, and control arrangements for electromagnetic coupler systems 10 are contemplated herein. Accordingly, some or all of the components described here can be included or omitted from various configurations and be included in, can be accessible to, and/or can be operable from any of the electromagnetic coupler systems 10, work machines 12, host machines 14, and/or control servers 17.

Generally, the electromagnetic coupler systems 10, work machines 12, and/or host machines 14 will include operator controls (40a, 40b), controllers (42a, 42b, 42c), sensors (44a, 44b, 44c, 44d), and/or user interfaces (46a, 46b).

Electromagnetic coupler systems 10, work machines 12, host machines 14, and/or control servers 17 can generate and report various items of information. To generate and report the information, electromagnetic coupler systems 10, work machines 12, host machines 14, and/or control servers 17 can each include a set of sensors (44a, 44b, 44c, 44d) and/or a set of controllers (42a, 42b, 42c). The sensors can be configured to enable monitoring of a variety of operating conditions, including real-time operating conditions of the respective machine or its components (e.g., engine, attachments, surroundings, proximity, stability, operating environment, and so forth).

The sensors (44a, 44b, 44c, 44d) can collect operating data, which can be transmitted by the controllers (42a, 42b, 42c), via the network 614, to one or more control servers 17. The network 614 can operate according to one or more wired or wireless protocols, such as Wi-Fi, cellular, radio, satellite, Bluetooth, ZigBee, etc. To enable transmission of data and traffic management, the network 614 can include connectivity equipment, such as modems, Bluetooth transceivers, Bluetooth beacons, RFID transceivers, NFC transmitters, and the like. In some implementations, the network 614 can include a controller area network (CAN) of a particular work machine 12 and/or host machine 14.

The sensors (44a, 44b, 44c, 44d) can provide analog readings and/or digital readings. According to various implementations, the sensors (44a, 44b, 44c, 44d) can include radar components, lidar components, cameras, ultrasonic devices, GPSs (global positioning systems), and/or other suitable components. The sensors can include components that provide two-dimensional (2D) or three-dimensional (3D) maps, readings, or information. For example, a sensor can include a camera capable of capturing light and/or other electromagnetic radiation through pixels (e.g., as in the case of a charge-couple device (CCD)). For example, a sensor can include a 2D arrangement of pixels (e.g., “cells”), each of which is capable of recording one or more signals (e.g., associated with photons of a particular range of wavelengths). In some implementations, a particular one of the electromagnetic coupler systems 10, work machines 12, and/or host machines 14 can include multiple such sensors, thereby enabling 3D mapping of objects in the vicinity of the respective machine. In some implementations, sensors (102a, 104a, 108a) can provide on-demand and/or periodic readings regarding positioning, temperature, voltage, current, electromagnetic activity, balance, or other operating parameters.

The controllers (42a, 42b, 42c) can activate, operate, and/or control sensors (44a, 44b, 44c, 44d), fuse (stitch together, aggregate) the readings of multiple sensors (44a, 44b, 44c, 44d), convert analog values to digital values, generate electronic messages containing sensor readings, and/or transmit sensor readings, via the network 614, to one or more control servers 17. The controllers (42a, 42b, 42c) can include hardware and/or software circuitry. Operations of the controllers (42a, 42b, 42c) can be performed, at least in part, by any suitable control unit, such as an engine control unit (ECU), powertrain control module (PCM), brake control module (BCM), speed control unit (SCU), transmission control module (TCM), battery management system (BMS), telematics control unit (TCU), and so forth.

An example controller (42a, 42b, 42c) can be an electronic controller that includes and/or is provided with one or more processor units and one or more memory units. The elements of an electronic controller (42a, 42b, 42c) can include, for instance, a processor/microcontroller, memory (e.g., SRAM, EEPROM, flash), input devices (supply voltage and ground, digital input devices, analog input devices), output devices (actuator drivers, such as injectors, relays, valves), logic outputs, communication circuitry and equipment (CAN transceivers, Ethernet transceivers, including wired and wireless communication components), and various embedded software modules (boot loaders, metadata, configuration data). Accordingly, in some implementations, controllers (42a, 42b, 42c) can be structurally and/or communicatively integrated with various sensors described herein.

In some implementations, the controllers (42a, 42b, 42c) can provide raw sensor data to the control server 17, which can perform edge computing operations, enable remote monitoring of the electromagnetic coupler systems 10, work machines 12, and/or host machines 14, and/or enable remote control of the electromagnetic coupler systems 10, work machines 12, and/or host machines 14. In some implementations, the controllers (42a, 42b, 42c) can be integrated at least in part with the control server 17. For example, the controllers (42a, 42b, 42c) can include the programming instructions (e.g., executables) distributed across or replicated to a particular on-board controller (42a, 42b, 42c) and control server 17.

In some implementations, the controllers (42a, 42b, 42c) can perform advanced control operations, such as proximity detection, coupling, spacing, alignment control, stabilization control, and/or emergency release, described further herein. To that end, the controllers (42a, 42b, 42c) can generate virtual sensor values using information provided by different sensors or types of sensors. For example, controllers (42a, 42b, 42c) can combine raw reflection data from lidar, radar, and/or ultrasonic sensors with raw frame data from camera sensors and/or additional data to more accurately estimate a distance from a first particular point on the electromagnetic coupler system 10, work machine 12, or host machine 14 to a second particular point on the electromagnetic coupler system 10, work machine 12, or host machine 14. For example, controllers (42a, 42b, 42c) can engage inertial movement unit (IMU) sensors to collect and process multi-axial acceleration data collected via accelerometer(s) of the IMU and/or multi-axial velocity data collected via gyroscope(s) of the IMU. For example, controllers (42a, 42b, 42c) can generate or compute multi-axial translational movement data (surge, heave, sway) and/or multi-axial rotational movement data (roll, pitch, yaw) for work machines 12, host machines 14, or components thereof. To that end, one of skill will appreciate that the corresponding sensors (44a, 44b, 44c, 44d) can be mounted at suitable surface points or joints of the electromagnetic coupler systems 10, work machines 12, host machines 14, or attachments thereto.

FIG. 1B is a component diagram showing example control mechanisms 100 of the electromagnetic coupler system 10, according to some arrangements. Although described here, for clarity, in connection with specific components according to example embodiments, control mechanisms 100 can be implemented on one or more local or distributed controllers, of which each can include one or more local or distributed memories. Control mechanisms 100 can include operations, which can include one or a combination of mechanical operations, sensing operations, computer-executable operations, and/or operator instructions.

Control mechanisms 100 can include a proximity detection mechanism 102 for automatic connection initiation, a coupling mechanism 104 for secure attachment, a spacing control mechanism 106 for distance regulation, an alignment control mechanism 108 for relative positioning of machines, a stabilization control mechanism 110 for steady connection, and/or an emergency release mechanism 112.

The proximity detection mechanism 102 in the electromagnetic coupler system 10 enables automatic connection initiation between work machine 12 and host machine 14. Sensors can detect the presence and/or proximity of coupling element 20 on work machine 12 and mounting element 18 on host machine 14. In response to detecting proximity, the controller can perform operations, including raising displayable and/or audible alerts, invoking coupling operations, invoking spacing operations, invoking alignment control operations, invoking stabilization control operations, invoking emergency release operations, and so forth.

Proximity sensors can include optical sensors, magnetic sensors, capacitive sensors, ultrasonic sensors, inductive sensors, camera sensors, or combinations thereof. The sensors can detect that the work machine 12 and host machine 14 are within a predetermined distance of one another, where the distance threshold can be controllable using a value stored in memory or provided by the operator via the interface and accessible by the controller. As an example of optical proximity sensing, infrared sensors on work machine 12 can detect host machine 14's presence. As another example of optical proximity sensing, photodiodes on mounting element 18 can monitor work machine 12's approach. As an example of magnetic proximity sensing, Hall effect sensors in electromagnet housing 16 can detect magnetic attraction element 32. As another example of magnetic proximity sensing, reed switches on coupling element 20 can sense host machine 14's magnetic field. As an example of capacitive proximity sensing, ultrasonic transducers on work machine 12 can emit sound waves, detecting host machine 14. As another example of capacitive proximity sensing, echo sensors on electromagnet housing 16 can calculate distance to coupling element 20. As an example of inductive proximity sensing, coil-based sensors on work machine 12 can detect electromagnet coils 24. As another example of inductive proximity sensing, inductive proximity sensors on mounting element 18 can monitor coupling element 20. As an example of camera proximity sensing, host machine 14's camera can monitor work machine 12's approach, and the controller can apply computer vision algorithms to detect proximity.

The coupling mechanism 104 can ensure secure attachment between work machine 12 and host machine 14. Coupling mechanisms can include locking pins on coupling element 20 engaging mounting element 18, magnetic attraction element 32 providing holding force, and/or supplying power to electromagnet coils 24 to cause the coils 24 to generate attractive forces. In some implementations, cam locks and/or wedge mechanisms can enhance connection stability. In some implementations, sensors and/or controllers can monitor coupling element 20's position and/or magnetic attraction element 32's strength.

In some implementations, the coupling mechanism 104 can include generating automatic control signals and/or operator instructions to activate or tune the coupling mode. For example, upon determining that the machines are within a predetermined distance and/or alignment threshold of one another, the controller can generate an operator alert for manual coupling or decoupling, and the operator controls can be utilized to perform the appropriate coupling/decoupling operations. For example, the controller can implement automatic timer- or sensor- (threshold-) based coupling/decoupling operations. For example, the controller can include a programmable logic controller (PCL) component that can implement sophisticated control conditions for coupling/decoupling operations.

Example coupling operations can include generating a control signal to cause the power supply 26 to initiate current flow to the coils 24, which can, in turn, generate a magnetic field. The coupling operations can enable high-power applications in industrial machinery and can cause the system 10 to operate in accordance with operating parameters such as currents ranging from 50 to 1000 A, voltages ranging from 480 to 600 VAC and/or 48 to 1000 VDC, or other operating parameters. In some implementations, the operating parameters can be set such that the capabilities of the system 10 are suited for heavy machinery and industrial drives. In some implementations, the operating parameters can be set in accordance with industry standards.

In some implementations, the coupling operations can be initiated after detecting that the work machine 12 and the host machine 14 are within a predetermined proximity threshold and/or in response to an operator control command (e.g., a command to engage (turn on, increase current or voltage) and/or a command to disengage (e.g., turn off, decrease current or voltage) the system 10. In some implementations, the operator control commands to engage and/or the coupling mechanism can be performed in a step-up fashion (e.g., by turning a dial to progressively increase or decrease current or voltage supply by N % or another predetermined step). In some implementations, the proximity detection operations can include initially engaging a first set of proximity sensors (e.g., low-resource consumption sensors) before coupling operations are initiated and subsequently engaging a second set of proximity sensors (e.g., higher-accuracy sensors) when the coupling mechanism 104, spacing control mechanism 106, alignment control mechanism 108, and/or stabilization control mechanism 110 are engaged.

The spacing control mechanism 106 can ensure optimal distance between electromagnet housing 16 and magnetic attraction element 32. For example, the controller can cause operations to be performed and/or operator instructions to be generated in order to maintain a target distance and/or a set of target distances for spacing control. A target distance can include a target distance value and/or range (e.g., +/−5% of target value, +/−10% of target value, +/−100% of target value). For example, a target distance for electromagnet housing 16 to magnetic attraction element 32 can be set to 1-10 mm (0.04-0.4 in). A target distance for the coupling element 20 to mounting element 18 can be set to 0.5-5 mm (0.02-0.2 in). A target distance for work machine 12 to host machine 14 can be set to 10-500 mm (0.4-19.7 in). In some implementations, the operator enables the machines to maintain a certain distance (e.g., a target distance, an operator-determined distance) by using operator controls (dials, switches, buttons, levers, touchscreens, and the like) to engage or disengage the coupling mechanism.

The sensors disposed on the electromagnetic coupler 10, work machine 12, and/or host machine 14 can facilitate distance regulation. For example, laser distance sensors, such as lidar or laser triangulation, can measure gap width. For example, ultrasonic sensors can emit sound waves, detecting spacing variations through echo analysis. For example, capacitive sensors can monitor proximity of coil 24 to magnetic attraction surface 32. For example, inductive sensors can track the position of magnetic attraction element 32 in relation to the housing 16, coil 24, or other components.

In some implementations, the controller can also implement distance regulation techniques to maintain target spacing. For example, the controller can cause the power supply 26 to adjust the current level to electromagnet coil 24 based on sensor readings. For example, in addition to distance between the work machine 12 and host machine 14, the controller can monitor velocity and/or acceleration of the work machine 12 and host machine 14. Using the distance, velocity, and/or acceleration values, the controller can generate soft-start signals for controlled acceleration and/or soft-stop signals for controlled deceleration of the work machine 12 and host machine 14 in order to reach a target distance between the machines.

The alignment control mechanism 108 can improve relative positioning of the work machine 12 and host machine 14. For example, the controller can engage camera and/or infrared sensors to monitor relative alignment and/or orientation (e.g., axial) of the housing 16, mounting element 18, and/or coupling element 20 to maintain a target alignment and/or orientation range (e.g., a target value +/−N degrees). Upon detecting that the alignment and/or orientation difference exceeds the target range, the controller can raise operator alerts, raise operator recommendations (e.g., for implementing mechanical alignment corrections by repositioning alignment guides), engage motors (e.g., stepper motors, servo motors), engage hydraulic/pneumatic systems, and so forth.

The stabilization control mechanism 110 can maximize reliability of the electromagnetic connection via the electromagnetic coupler system 10. For example, the controller can engage a sensor to monitor the temperature of the electromagnet coil 24 to ensure that the temperature is in a target range. In some implementations, the target range can be automatically determined based on, for example, the respective weights of the work machine 12 and host machine 14.

The emergency release mechanism 112 can enable rapid decoupling of the work machine 12 and host machine 14 in certain situations. Sensors can be engaged to detect anomalies, such as incline, relative positioning values, relative alignment values, speed, and/or operating state of various subsystems (braking, engine, transmission), in operation of the work machine 12 and/or host machine 14. Further, sensors can be engaged to detect anomalies, such as coil 24 temperature, power supply 26 operability, housing 16 condition, mounting element 18 condition, and/or coupling element 20 condition, in operation of the electromagnetic coupler system 10. After detecting such anomalies (e.g., upon determining that sensor values exceed automatically determined, predetermined, and/or operator-supplied thresholds), the controller can trigger decoupling operations. For example, the electromagnet coils 24 can be deactivated by cutting electrical current thereto, releasing magnetic attraction element 32. For example, spring-loaded mechanisms can be activated to assist in rapidly separating coupling element 20 from mounting element 18.

In some implementations, to perform various aforementioned operations of the control mechanism 100 or sequences thereof, the controller can cause the power supply 26 to provide or cease providing power (e.g., at a certain voltage) to the electromagnetic coils 24 in order to engage, calibrate, or disengage the electromagnetic coupler system 10. For example, the controller can cause the power supply 26 to cease providing power to the electromagnetic coils 24 after engaging the emergency release mechanism.

In some implementations, the controller can implement various computer-based control techniques. For example, the controller can apply model predictive control (MPC) techniques, feedback control techniques, adaptive control techniques, fuzzy logic control techniques, and/or artificial neural networks to optimize synchronization of the work machine 12 and the host machine 14 to optimize operations of the electromagnet coupler system 10, to generate recommendations for alert-related thresholds (distance thresholds, alignment thresholds, anomaly conditions), and so forth.

### Example Use Cases for the Electromagnetic Coupler System

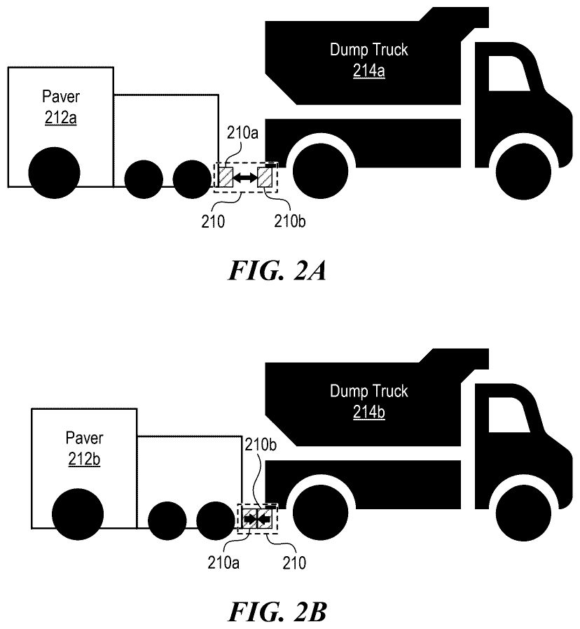

FIGS. 2A, 2B, 3, and 4 are component diagrams showing example use cases for the electromagnetic coupler system 10, according to some arrangements.

In an example of FIG. 2A and FIG. 2B, a dump truck (214a, 214b) can act as a host device 14 and can be connected to a paver (212a, 212b) in road construction and asphalt-laying projects. As shown in FIG. 2A, the dump truck (214a, 214b) can be connected to the paver (212a, 212b) via the electromagnetic coupler system 210, according to some arrangements. The electromagnetic coupler system 210 can include a first set of components 210a disposed on or connected to the paver (212a, 212b) and a second set of components 210b disposed on or connected to the dump truck (214a, 214b). The respective sets of components can include sets or subsets of elements of the electromagnetic coupler system 210 in any suitable combination. An example set of elements of the electromagnetic coupler system 210 can include controllers, sensors, mounting elements, coupling elements, electromagnetic devices (e.g., housing, coil, power supply), user interfaces, displays, operator controls, and so forth.

The electromagnetic coupler system 210 can be operable to connect (FIG. 2A), keep a particular spacing between, and disconnect (FIG. 2B) components 210a and 210b based on various criteria, such as operator commands, timer commands, proximity detection, out-of-range operating parameter detection, emergency condition detection, and so forth. For example, to maintain a particular distance or disconnect the machines, the magnets can repulse each other to keep the machines from colliding. As the machines approach each other, the repulsing forces keep the machines apart until relative speed levels of the machines are well matched. Then, the repulsing force can be reduced until the machines become positioned within a predetermined distance of one another. At that point the magnetic forces can be reversed to hold the machines together until it is time to separate again. The trigger conditions for engaging or disengaging the mechanism (e.g., for increasing or reducing magnetic or repulsing forces) can include target distances, operator control commands, internal (machinery or sensor) control commands, emergency stop control signals, or other suitable events or control commands, whether automatically detected or manually supplied.

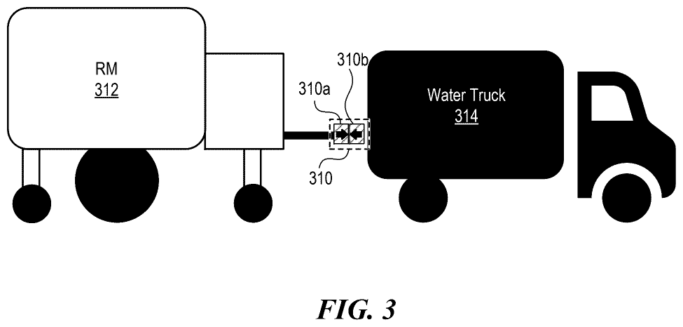

In an example of FIG. 3, a water truck 314 can act as a host device 14 and can be connected to a mixer 312. As shown in FIG. 3, the water truck 314 can be connected to mixer 312 via the electromagnetic coupler system 310, according to some arrangements. The electromagnetic coupler system 310 can include a first set of components 310a disposed on or connected to the mixer 312 and a second set of components 310b disposed on or connected to the water truck 314. The respective sets of components can include sets or subsets of elements of the electromagnetic coupler system 310 in any suitable combination. An example set of elements of the electromagnetic coupler system 310 can include controllers, sensors, mounting elements, coupling elements, electromagnetic devices (e.g., housing, coil, power supply), user interfaces, displays, operator controls, and so forth. The electromagnetic coupler system 310 can be operable to connect and disconnect components 310a and 310b based on various criteria, such as operator commands, timer commands, proximity detection, out-of-range operating parameter detection, emergency condition detection, and so forth.

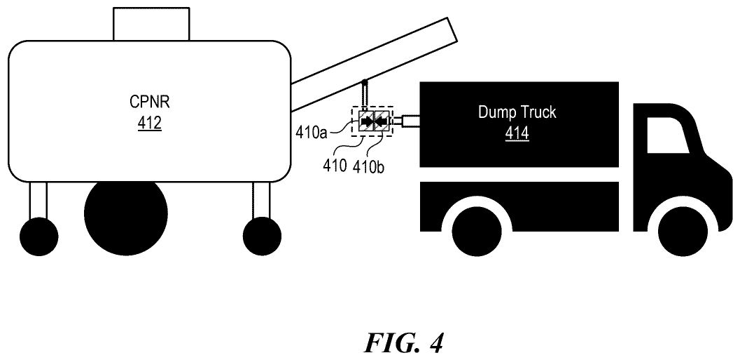

In an example of FIG. 4, a dump truck 414 can act as a host device 14 and can be connected to a cold planer 412. The relative positions of the dump truck 414 and the cold planer 412 can be controlled via the mechanism described here to ensure accurate and complete loading of the dump truck 414. For example, as shown in FIG. 4, the dump truck 414 can be connected to cold planer 412 via the electromagnetic coupler system 410, according to some arrangements. The electromagnetic coupler system 410 can include a first set of components 410a disposed on or connected to the cold planer 412 and a second set of components 410b disposed on or connected to the dump truck 414. The respective sets of components can include sets or subsets of elements of the electromagnetic coupler system 410 in any suitable combination. An example set of elements of the electromagnetic coupler system 410 can include controllers, sensors, mounting elements, coupling elements, electromagnetic devices (e.g., housing, coil, power supply), user interfaces, displays, operator controls, and so forth. The electromagnetic coupler system 410 can be operable to connect and disconnect components 410a and 410b based on various criteria, such as operator commands, timer commands, proximity detection, out-of-range operating parameter detection, emergency condition detection, and so forth.

### Example Control Methods for the Electromagnetic Coupler System

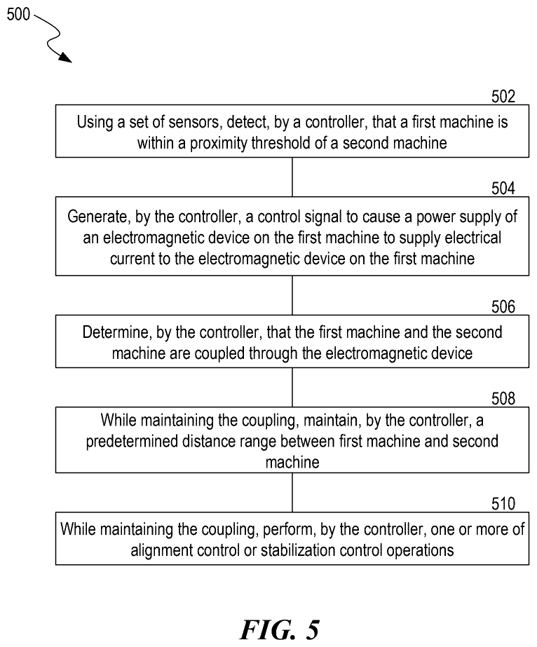

FIG. 5 is a flowchart showing an example control method 500 for the electromagnetic coupler system, according to some arrangements. One of skill will appreciate that operations described herein can be performed by any suitable component or components in various combinations thereof. For example, although the term “controller” is used in singular form, for clarity, this term is intended to encompass distributed controller implementations and/or sets of controllers, which can be physically, logically, and/or geographically separate.

In an example implementation, an electromagnetic coupler system for controllably connecting a first industrial machine to a second industrial machine can include an electromagnetic device disposed on the first industrial machine and having a power supply. The system can additionally include a mounting element disposed on the second industrial machine and including an electromagnetic attraction surface. The system can additionally include a controller. The controller can include at least one processor and at least one memory unit. The at least one memory unit can have instructions stored thereon that, when executed by the at least one processor, cause the controller to perform operations.

At operations 502, the controller can detect that the mounting element is within a proximity threshold of the electromagnetic device or, more generally, that the first industrial machine is within a proximity threshold of the second machine. The proximity threshold can relate to a target distance or range sufficient for coupling the first industrial machine and the second industrial machine. In some implementations, the target distance is a numerical value or range (e.g., a value in millimeters, centimeters, inches, meters). In some implementations, the target distance is a confidence threshold for automatic object recognition using computer vision. In some implementations, the operations at 502 are bypassed. For example, two particular machines can be rigidly connected via an electromagnetic device, and the controller can monitor the relative positions of the electromagnets relative to the machines.

At operations 504, the controller can cause the power supply to supply electrical current to the electromagnetic device. In some implementations, the controller can determine a target temperature range for an electromagnet coil of the electromagnetic device. While maintaining a target distance range between the first industrial machine and the second industrial machine, the controller can generate control signals to periodically measure the target temperature range of the electromagnet coil, for example, by controlling operation of the power supply to increase or decrease the current flowing to the electromagnetic device or otherwise regulate the coil temperature in the electromagnetic device.

At operations 506, the controller can determine, using a second set of proximity detection sensors, that at least a portion of the electromagnetic attraction surface is coupled to the electromagnetic device. The portion can include an area sufficient to maintain a connection between the machines via the electromagnetic device.

At operations 508, the controller can maintain a target distance range between the first industrial machine and the second industrial machine. For example, the controller can invoke the coupling and/or spacing mechanism as described herein. The target distance range can be determined in relation to a first point on an electromagnet housing of the electromagnetic device and a second point on the electromagnetic attraction surface or the first point on the electromagnet housing and a third point on the mounting element. In some implementations, the controller can, upon determining that one or more of a target distance, velocity, or acceleration of the first industrial machine and the second industrial machine are outside of a predetermined range, generate an acceleration or deceleration control signal for the first industrial machine or the second industrial machine.

At operations 510, the controller can perform additional alignment, orientation, and/or stabilization control operations. In some implementations, the controller can perform alignment control operations for the first industrial machine and the second industrial machine by determining a target alignment range for the first industrial machine and the second industrial machine. While maintaining the target distance range between the first industrial machine and the second industrial machine, the controller can generate a control signal to maintain the target alignment range.

According to various implementations, the controller can generate operator alerts pertaining to an operating status of the electromagnetic coupler system (e.g., coupled, decoupled, emergency decoupled, distance, alignment, and so forth), the operator alert being displayable at a first display device associated with the first industrial machine, a second display device associated with the second industrial machine, or both.

### Example Computer System

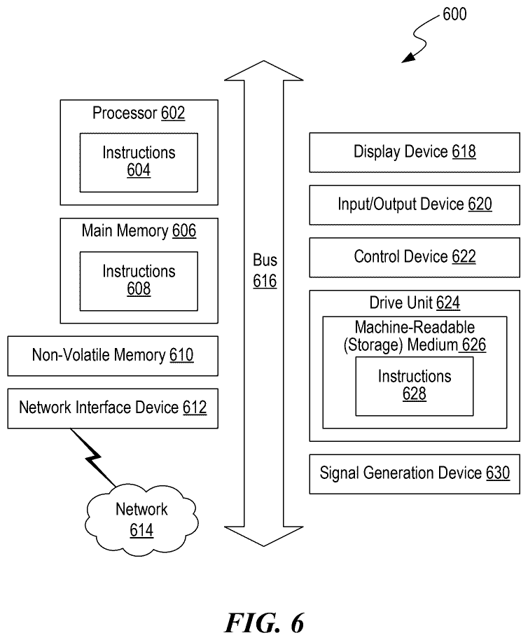

FIG. 6 is a block diagram that illustrates an example of a computer system in which at least some operations described herein can be implemented. As shown, the computer system 600 can include one or more processors 602, main memory 606, non-volatile memory 610, a network interface device 612, a display device 618, an input/output device 620, a control device 622 (e.g., keyboard and pointing device), a drive unit 624 that includes a storage medium 626, and a signal generation device 630 that is communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture as that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 600. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computer system 600 to mediate data in a network 614 with an entity that is external to the computer system 600 through any communication protocol supported by the computer system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 928. The machine-readable (storage) medium 626 can include any medium that is capable of storing, encoding, or carrying a set of instructions for execution by the computer system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

### Industrial Applicability

Disclosed herein is an intelligent electromagnetic coupler system for industrial machines, such as trucks. The system can include an electromagnetic device on a first machine and a coupling element on a second machine. The coupling element can include an electromagnetic attraction surface to connect the coupling element to at least a portion of the electromagnetic device.

In some implementations, in response to detecting, via a set of sensors, that the coupling element is within a proximity threshold of the electromagnetic device, a controller can generate control signals to perform machine coupling/decoupling operations. After the industrial machines are connected via the intelligent electromagnetic coupler, the controller can perform alignment control operations, stability control operations, and/or emergency release operations while maintaining a target distance range between the connected industrial machines.

In some implementations, in response to one or both of: (i) detecting, utilizing a set of proximity detection sensors, that the coupling element is within a proximity threshold of the electromagnetic device, or (ii) receiving a control instruction to engage the electromagnetic device, the controller can cause the power supply to supply electrical current to the electromagnetic device to engage the electromagnetic device; and after performing one or both of: (iii) determining, using a second set of proximity detection sensors, that at least a portion of the electromagnetic attraction surface is coupled to the electromagnetic device, or (iv) receiving a control instruction to disengage the electromagnetic device, the controller can cause the electromagnetic device to disengage, Causing the electromagnetic device to disengage can include at least one of: (a) reversing polarity of the electrical current to generate a repulsing force that separates the coupling element from the electromagnetic device, (b) reducing the electrical current, or (c) cutting off the electrical current.

### Remarks

The terms “example,” “embodiment,” and “implementation” are used interchangeably. For example, references to “one example” or “an example” in the disclosure can be, but are not necessarily, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. An electromagnetic coupler system for controllably connecting a first industrial machine to a second industrial machine, the system comprising:
an electromagnetic device disposed on the first industrial machine and having a power supply;
a coupling element disposed on the second industrial machine and including an electromagnetic attraction surface; and
a controller comprising at least one processor and at least one memory unit, the at least one memory unit having instructions stored thereon that, when executed by the at least one processor, cause the controller to:
in response to detecting, utilizing a set of proximity detection sensors, that the coupling element is within a proximity threshold of the electromagnetic device, cause the power supply to supply electrical current to the electromagnetic device; and
after determining, using a second set of proximity detection sensors, that at least a portion of the electromagnetic attraction surface is coupled to the electromagnetic device, maintain a target distance range between the first industrial machine and the second industrial machine.

2. The system of claim 1, wherein the proximity threshold relates to a target distance range sufficient for coupling the first industrial machine and the second industrial machine, the instructions further comprising maintaining the target distance range between the first industrial machine and the second industrial machine.

3. The system of claim 2, wherein the target distance range is determined in relation to a first point on an electromagnet housing of the electromagnetic device and a second point on the electromagnetic attraction surface, or the first point on the electromagnet housing and a third point on the coupling element.

4. The system of claim 3, wherein the instructions further cause the controller to maintain the target distance range by:
upon determining that one or more of a target distance, velocity, or acceleration of the first industrial machine and the second industrial machine are outside of a predetermined range, generating an acceleration or deceleration control signal for the first industrial machine or the second industrial machine.

5. The system of claim 1, wherein the instructions further cause the controller to perform connection stabilization control operations by:
determining a target temperature range for an electromagnet coil of the electromagnetic device; and
while maintaining a target distance range between the first industrial machine and the second industrial machine, maintaining the target temperature range of the electromagnet coil.

6. The system of claim 1, wherein the instructions further cause the controller to perform alignment control operations for the first industrial machine and the second industrial machine by:
determining a target alignment range for the first industrial machine and the second industrial machine; and
while maintaining a target distance range between the first industrial machine and the second industrial machine, generating a control signal to maintain the target alignment range.

7. The system of claim 1, wherein the controller is configured to generate an operator alert pertaining to an operating status of the electromagnetic coupler system, the operator alert being displayable at a first display device associated with the first industrial machine, a second display device associated with the second industrial machine, or both.

8. An electromagnetic coupler system for controllably connecting a first industrial machine to a second industrial machine, the system comprising:
an electromagnetic device disposed on the first industrial machine and having a power supply;
a coupling element disposed on the second industrial machine and including an electromagnetic attraction surface; and
a controller comprising at least one processor and at least one memory unit, the at least one memory unit having instructions stored thereon that, when executed by the at least one processor, cause the controller to:
in response to one or both of: (i) detecting, utilizing a set of proximity detection sensors, that the coupling element is within a proximity threshold of the electromagnetic device, or (ii) receiving a control instruction to engage the electromagnetic device, cause the power supply to supply electrical current to the electromagnetic device to engage the electromagnetic device; and
after performing one or both of: (iii) determining, using a second set of proximity detection sensors, that at least a portion of the electromagnetic attraction surface is coupled to the electromagnetic device, or (iv) receiving a control instruction to disengage the electromagnetic device, cause the electromagnetic device to disengage.

9. The system of claim 8, wherein the controller causes the power supply to supply electrical current to the electromagnetic device to engage the electromagnetic device in response to detecting, utilizing the set of proximity detection sensors, that the coupling element is within the proximity threshold of the electromagnetic device.

10. The system of claim 9, wherein the proximity threshold relates to a target distance range sufficient for coupling the first industrial machine and the second industrial machine, the instructions further comprising maintaining the target distance range between the first industrial machine and the second industrial machine.

11. The system of claim 10, wherein the target distance range is determined in relation to a first point on an electromagnet housing of the electromagnetic device and a second point on the electromagnetic attraction surface, or the first point on the electromagnet housing and a third point on the coupling element.

12. The system of claim 11, wherein the instructions further cause the controller to maintain the target distance range by:
upon determining that one or more of a target distance, velocity, or acceleration of the first industrial machine and the second industrial machine are outside of a predetermined range, generating an acceleration or deceleration control signal for the first industrial machine or the second industrial machine.

13. The system of claim 8, wherein the electromagnetic device disengages after determining, using the second set of proximity detection sensors, that the at least a portion of the electromagnetic attraction surface is coupled to the electromagnetic device.

14. The system of claim 8, wherein causing the electromagnetic device to disengage includes at least one of: (a) reversing polarity of the electrical current to generate a repulsing force that separates the coupling element from the electromagnetic device, (b) reducing the electrical current, or (c) cutting off the electrical current.

15. A method, comprising:
in response to detecting, utilizing a set of proximity detection sensors, that a coupling element at a first industrial machine is within a proximity threshold of an electromagnetic device of a second industrial machine, causing a power supply of the electromagnetic device to supply electrical current to the electromagnetic device; and
after determining, using a second set of proximity detection sensors, that at least a portion of an electromagnetic attraction surface of the coupling element is coupled to the electromagnetic device, maintaining a target distance range between the first industrial machine and the second industrial machine.

16. The method of claim 15, wherein the proximity threshold relates to a target distance range sufficient for coupling the first industrial machine and the second industrial machine.

17. The method of claim 16, wherein the target distance range is determined in relation to a first point on an electromagnet housing of the electromagnetic device and a second point on the electromagnetic attraction surface, or the first point on the electromagnet housing and a third point on the coupling element.

18. The method of claim 17, further comprising:
upon determining that one or more of a target distance, velocity, or acceleration of the first industrial machine and the second industrial machine are outside of a predetermined range, generating an acceleration or deceleration control signal for the first industrial machine or the second industrial machine.

19. The method of claim 15, further comprising:
determining a target alignment range for the first industrial machine and the second industrial machine; and
while maintaining the target distance range between the first industrial machine and the second industrial machine, generating a control signal to maintain the target alignment range.

20. The method of claim 15, further comprising generating an operator alert pertaining to an operating status of an electromagnetic coupler system, the operator alert being displayable at a first display device associated with the first industrial machine, a second display device associated with the second industrial machine, or both.
